(19) United States
(12) Patent Application Publication
(10) Pub. No.: US 2007/0238971 A1
(43) Pub. Date: Oct. 11, 2007

(54) Apparatus and method for two-and three-dimensional magnetic resonance imaging using ferromagnetic spheres

(75) Inventors: Mladen Barbic, San Gabriel, CA (US); Axel Scherer, Laguna Beach, CA (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: California Institute of Technology, Pasadena, CA (US)

(21) Appl. No.: 11/649,643

(22) Filed: Jan. 4, 2007

Related U.S. Application Data
(60) Provisional application No. 60/756,462, filed on Jan. 4, 2006.

(51) Int. Cl. G01V 3/00

(52) U.S. Cl. 600/410; 324/309

(57) ABSTRACT

Systems and methods for obtaining two- and three-dimensional magnetic resonance images by using azimuthally symmetric dipolar magnetic fields from magnetic spheres. A complete two- or three-dimensional structured rendering of a sample can be obtained without the motion of the sample relative to the sphere. Magnetic spheres in the range of 100 μm and 100 nm are used with samples that are approximately one-tenth as large as the magnetic sphere. Sequential positioning of the integrated sample-sphere system in an external magnetic field at various angular orientations provides all the required imaging slices for successful computerized tomographic image reconstruction. The requirement to scan the sample relative to the magnetic tip is eliminated. Resolutions approaching atomic dimensions are expected to be obtained.

### CROSS-REFERENCE TO RELATED APPLICATIONS

This application claims priority to and the benefit of co-pending U.S. provisional patent application Ser. No. 60/756,462, filed Jan. 4, 2006, which application is incorporated herein by reference in its entirety.

### STATEMENT REGARDING FEDERALLY FUNDED RESEARCH OR DEVELOPMENT

The invention described herein was made in the performance of work under NIH Grant No. NIH-RO1 HG002644 and NSF CAREER Award Grant No. 0349319, and is subject to the provisions of Public Law 96-517 (35 U.S.C. §202) in which the Contractor has elected to retain title.

### FIELD OF THE INVENTION

The invention relates to apparatus and methods for obtaining magnetic resonance images in general and particularly to apparatus and methods that employ a ferromagnetic sphere that does not move relative to a sample that is being measured.

### BACKGROUND OF THE INVENTION

There has been a steady advance in the field of Magnetic Resonance Imaging (MRI) towards higher resolution, with the ultimate goal of atomic imaging capability. The largest measurement challenges stem from weak signals typical of high-resolution magnetic resonance, and the limitation of available gradient field strengths from current carrying conductors. Following the original reports of applying magnetic field gradients to samples in order to demonstrate magnetic resonance imaging of spatial spin distribution, improvements in conventional inductive detection have resulted in spatial imaging resolution of approximately 1 μm. The attraction and intense research interest towards 3D MRI with higher resolution is driven by the well-known advantages of MRI as a three-dimensional, non-invasive, multi-contrast, and chemically specific imaging tool.

The introduction of ferromagnetic nanostructures for increased sensitivity and resolution in magnetic resonance imaging has opened additional avenues toward achieving the atomic resolution goal. Scaling considerations show that a miniaturized permanent magnet will produce higher fields than an electromagnet, and can be further scaled to a smaller size without any loss in field strength. Miniaturization of permanent magnets also provides an increase in the magnetic field gradients while requiring no electrical power supply and no current leads. Finally, due to the quantum mechanical exchange interaction responsible for ferromagnetism, permanent magnets generate no heat and thus require no heat dissipation.

This ability of nanometer scale ferromagnets to provide ultra-high magnetic field gradients that can in turn spatially resolve resonant spins on the atomic scale, as well as exert forces on the spins that can be detected with resonant mechanical detectors, has led Sidles to propose the Magnetic Resonance Force Microscope (MRFM). In this instrument, a microscopic magnetic particle on a mechanical cantilever acts as a source of atomic scale imaging gradient fields as well as a force generator on the spins whose magnetic resonance the mechanical cantilever detects. Proof-of-concept MRFM demonstrations have already been demonstrated for electron spin resonance, nuclear magnetic resonance, and ferromagnetic resonance, and the mechanical detection of a single electron spin has recently been accomplished.

There is an unmet need to provide systems and methods to enable single nuclear spin detection and atomic imaging using NMR methodology. Such capability would provide significant benefits in molecular imaging applications.

### SUMMARY OF THE INVENTION

In one aspect, the invention relates to an apparatus for obtaining a nuclear magnetic resonance image. The apparatus comprises a magnetic field generator configured to generate a large polarizing DC magnetic field B₀ and a small radio frequency field B₁ oriented perpendicular to the large polarizing DC magnetic field B₀; a specimen holder configured to support a specimen comprising an object of interest attached in fixed relation to a magnetic sphere, the specimen holder configured to permit the specimen to be oriented at a plurality of orientations relative to the large polarizing DC magnetic field B₀; a sensor for sensing a nuclear magnetic resonance signal; and an analyzer for analyzing the sensed nuclear magnetic signals. The apparatus is configured to generate at least one nuclear magnetic resonance image of the object of interest.

In one embodiment, the apparatus further comprises a general purpose programmable computer programmed with software, the general purpose programmable computer configured to control at least a selected one of the applied magnetic field, the operation of the magnetic field generator, and the relative orientations of the specimen and the applied magnetic field.

In one embodiment, the magnetic field generator comprises a superconducting solenoid. In one embodiment, the large polarizing DC magnetic field B₀ comprises a magnetic field of at least 10 Tesla. In one embodiment, the specimen holder is configured to allow rotation of the specimen along at least one of two mutually perpendicular rotation axes. In one embodiment, the magnetic sphere has a diameter of 100 μm or less. In one embodiment, the magnetic sphere has a diameter of 100 nm or less. In one embodiment, the magnetic sphere comprises a selected one of cobalt, iron, and nickel. In one embodiment, the magnetic sphere is a selected one of a ferromagnetic sphere and a ferromagnetic sphere.

In another aspect, the invention features a method for obtaining a nuclear magnetic resonance image. The method comprises the steps of attaching an object of interest in a fixed relation to a magnetic sphere to produce a specimen; placing the specimen in a sample holder; orienting the specimen with respect to an applied magnetic field by manipulating the sample holder to rotate the specimen along at least one of two mutually perpendicular rotation axes; recording a nuclear magnetic signal from the specimen at the orientation; reorienting the specimen with respect to the applied magnetic field; recording a nuclear magnetic signal from the specimen in the reoriented position; and analyzing the recorded nuclear magnetic signals to obtain an image of the object of interest.

In one embodiment, the steps of reorienting the specimen with respect to the applied magnetic field and recording a nuclear magnetic signal from the specimen in the reoriented position are repeated iteratively. In one embodiment, the magnetic sphere comprises a selected one of cobalt, iron, and nickel. In one embodiment, the magnetic sphere is a selected one of a ferromagnetic sphere and a ferromagnetic sphere. In one embodiment, the magnetic sphere has a diameter of 100 μm or less. In one embodiment, the magnetic sphere has a diameter of 100 nm or less. In one embodiment, at least one of the step of orienting the specimen with respect to an applied magnetic field and the step of reorienting the specimen with respect to the applied magnetic field is performed using a general purpose programmable computer. In one embodiment, the step of recording a nuclear magnetic signal from the specimen is performed using a general purpose programmable computer. In one embodiment, the step of analyzing the recorded nuclear magnetic signals is performed using a general purpose programmable computer.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1(a) is a diagram illustrating a model configuration for two-dimensional magnetic resonance tomography using magnetic spheres, such as ferromagnetic spheres or ferromagnetic spheres.

FIG. 1(b) is a diagram illustrating the relative position of the imaging contours along the plane parallel to the two-dimensional sample surface.

FIG. 2(a) is a diagram illustrating an alternative procedure for proper image slicing by sequential rotations around the y- and x-axes, according to principles of the invention.

FIG. 2(b) is a diagram illustrating a single rotation around the z-axis that would result in an incorrect rotation of the sample for proper slicing by the magnetic field imaging contours.

FIG. 3 is a diagram that illustrates a precessing ferromagnetic sphere moment reference frame for a two-dimensional sample, according to principles of the invention.

FIG. 4(a) is a diagram that illustrates how a rotation of the integrated sample/sphere system from 0=54.7° to 0=0° results in the sequential slicing of the three-dimensional sample by the imaging planes that range from being approximately perpendicular to the sphere surface to being approximately parallel to the sphere surface, according to principles of the invention.

FIG. 4(b) is a diagram that illustrates the precessing magnetic moment reference frame for the three-dimensional tomography, according to principles of the invention.

FIG. 5 is a cross-sectional diagram of a commercial superconducting magnet.

FIG. 6 is an illustration of a commercially available specimen holder that provides at least two mutually perpendicular axes of rotation.

FIG. 7 is a flow diagram illustrating one embodiment of the method of operation of the apparatus, according to principles of the invention.

### DETAILED DESCRIPTION OF THE INVENTION

We utilize the symmetric property of a geometric sphere in the presence of a large externally applied magnetic field that orients the sphere's magnetic moment along the field direction to demonstrate that a complete two- or three-dimensional structured rendering of a sample can be obtained without the motion of the sample relative to the sphere. We demonstrate that sequential positioning of the integrated sample-sphere system in an external magnetic field at various angular orientations provides all the required imaging slices for successful computerized tomographic image reconstruction. The elimination of the requirement to scan the sample relative to the ferromagnetic tip in this imaging protocol is a potentially valuable simplification compared to previous atomic resolution magnetic resonance imaging proposals. The present invention also contemplates obtaining images at resolutions on scales greater than atomic resolution (for example, micron resolution or resolution at even larger dimensions) using systems and methods in which there is no motion of the sample relative to the sphere.

We focus on the magnetic resonance imaging protocol with a new look at the interaction between a sample and the imaging gradients from a geometrically symmetric ferromagnetic sphere. We believe that the use of such a sphere model is reasonable, as ferromagnetic spheres have been successfully fabricated on the microscopic scale and integrated as probes on cantilever structures. We describe a two-dimensional imaging protocol first, before expanding this principle to the full three-dimensional method.

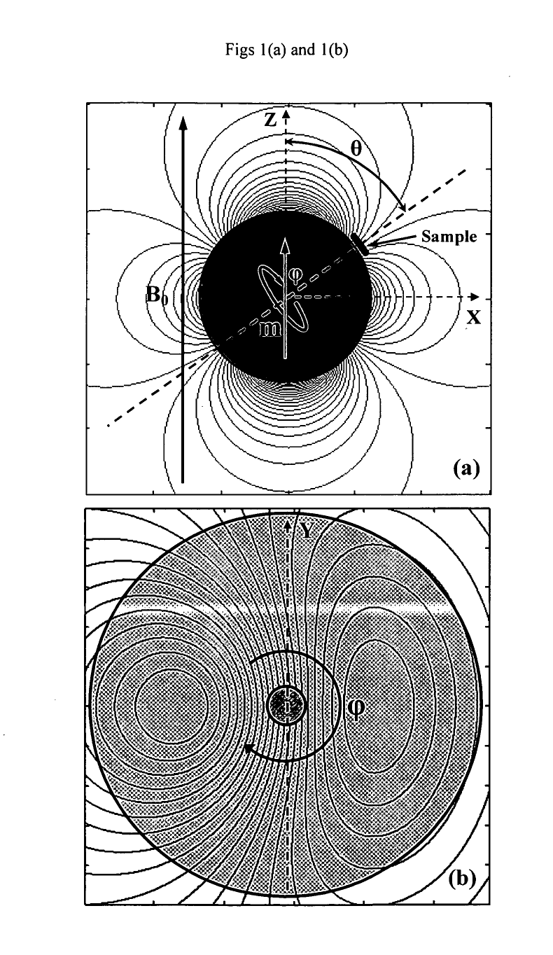

FIG. 1(a) is a diagram illustrating a model configuration for two-dimensional magnetic resonance tomography using magnetic spheres, such as ferromagnetic spheres or ferromagnetic spheres. Imaging contours of constant z-component of the magnetic field are perpendicular to the sphere surface and intersect the sample positioned at θ=54.7°. FIG. 1(b) is a diagram illustrating the relative position of the imaging contours along the plane parallel to the two-dimensional sample surface. The magnetic resonance spectrum of the sample is a one-dimensional projection of the sample spin density. Sequential rotations by angle φ provide the required projections for the tomographic image reconstruction process.

Our model configuration is shown in FIG. 1(a), where a sample or an object of interest with size of ˜ 1/10 the size of the ferromagnetic sphere is positioned in fixed orientation with regard to the ferromagnetic sphere as shown. The sample can represent either a small molecule or protein of ˜10 nm in size next to a 100 nm diameter ferromagnetic sphere, or a biological cell of ˜10 μm in size next to a sphere 100 μm in diameter. Other sizes of magnetic spheres can also be used, with the recognition that the effects described herein scale according to the dimension of the sphere, with larger spheres providing imaging resolution at larger dimensions.

Reports of fabrication of microspheres of cobalt and iron appear in the published literature (see, for example, Materials Science and Engineering: C, Volume 25, Issue 1, January 2005, pages 39-41). It is expected that the methods described herein can also be performed in other embodiments using microspheres comprising other magnetic metals, such as nickel; using microspheres of magnetic alloys that comprise any of iron, cobalt or nickel; using ferrimagnetic materials in place of ferromagnetic materials; or using other magnetic materials that can be fabricated in the form of spheres of suitable dimensions, including such materials as amorphous magnetic materials or oxide magnetic materials. The magnetic particles contained in ferrofluids have a nominal diameter of 10 nm (0.01 microns) and are single domain (see, for example, http://www.ferrotec.com/products/ferrofluid/bioMedical/applicationNote.php). Numerous papers on fabrication and use of magnetic micro- and nonspheres can be found in the proceedings of the 4^{th} International Conference on the Scientific and Clinical Applications of Magnetic Carriers, held at Tallahasse, Fla., during May 9-11, 2002 and the 5th International Conference on the Scientific and Clinical Applications of Magnetic Carriers, held in Lyon, France, during May 20-22, 2004. An example of binding specific substances to microparticles of magnetic materials is described in the presentation entitled “Specific Blood Purification by means of Antibody-Conjugate Magnetic Microspheres” that was given at the 1^{st} International Conference on the Scientific and Clinical Applications of Magnetic Carriers, held at Rostock, Germany, during Sep. 5-7, 1996. One can coat a magnetic microsphere with a substance that preferably binds to a specific chemical substance or chemical reaction site, so as to adhere an object of interest, such as a microparticle of a substance of interest that is to be examined, to the magnetic microsphere. Various additional articles about uses of magnetic microspheres can be viewed at the web page http://www.magneticmicrosphere.com/.

In one embodiment, a large DC magnetic field B₀(˜10 Tesla) is applied parallel to the z-direction, polarizing the spins of the sample as well as saturating the magnetization of the ferromagnetic sphere. Magnetic fields of many Tesla can be generated using such magnets as superconducting solenoid magnets, which have open regions (bores) into which specimens intended to be subjected to the generated magnetic field can be placed. A small radio frequency field B₁ is applied perpendicular to the large polarizing DC magnetic field B₀. In the absence of the ferromagnetic sphere, the nuclear spins in the sample would experience the same externally applied field B₀ and therefore meet the magnetic resonance condition at the same magnetic resonance frequency ω_{R}. However, close to the ferromagnetic sphere, a large magnetic field gradient is present at the sample, and only certain spins of the sample satisfy the correct magnetic resonance condition at any given magnetic field and frequency:
ω(\vec{r})=γ|v(\vec{r}) (1)

The magnetic field from the ferromagnetic sphere at point r in the sample has the following azimuthally symmetric dipolar form

$$\vec{B} ( \vec{r} ) = \frac{3 \vec{n} ( \vec{m} \cdot \vec{n} ) - \vec{m}}{{\vert \vec{r} \vert}^{3}} \qquad ( 2 )$$

where n is the unit vector that points from the center of the ferromagnetic sphere to the sample location, and m is the magnetic moment vector of the sphere. Since the external DC polarizing magnetic field B₀ is considered to be much larger than the field from the ferromagnetic sphere, only the z-component of the magnetic field from the ferromagnetic sphere, B_{z}, needs to be considered for imaging. For a ferromagnetic sphere, this z-component of the magnetic field has the azimuthally symmetric form:

$${B}_{Z} ( \vec{r} ) = \frac{{M}_{0}}{{\vert \vec{r} \vert}^{3}} ( 3 {cos}^{2} θ - 1 ) \qquad ( 3 )$$

where θ is the angle between the z-axis and the distance vector r, and M₀ is the magnitude of the saturation magnetic moment of the ferromagnetic sphere. FIG. 1(a) also shows the contours of constant values for the z-component of the magnetic field from the sphere, B_{z}, along the x-z plane.

In contrast to approaches we have previously taken, we propose to fix the sample directly on the sphere, as shown in FIG. 1(a), at an angular location where:

$$\frac{\partial {B}_{Z} ( \vec{r} )}{\partial r} = - 3 \frac{{M}_{0}}{{\vert \vec{r} \vert}^{4}} ( 3 {cos}^{2} θ - 1 ) = 0 \qquad ( 4 )$$

At this angular orientation of θ=54.7°, B_{z}≈0, and the contours of constant z-component of the magnetic field B from the ferromagnetic sphere are perpendicular to the sphere surface, so that the sample is intersected by approximately perpendicular imaging slices. In FIG. 1(b), the contours of constant z-component of the magnetic field from the ferromagnetic sphere are shown along the plane parallel to the two-dimensional sample surface. This view shows that the magnetic resonance spectrum of the two-dimensional sample (i.e., the configuration shown in FIG. 1) will be a one-dimensional projection of the sample spin density. This leads to the possibility of obtaining a computerized tomographic image if multiple imaging slices from the dipolar field of the ferromagnetic sphere can be obtained at different angles, as we describe below.

The imaging slices at multiple angles required for the computerized tomographic image reconstruction process can be obtained from a configuration of FIG. 1 without the motion of the sample relative to the sphere. We come to this conclusion by considering what happens when the integrated sample/sphere system is jointly rotated by an angle φ around the θ=54.7° axis, as shown in FIG. 1. Although both the sample and the sphere are mechanically rotated by the same angle φ, the presence of a large polarizing magnetic field B₀ of ˜10 Tesla along the z-axis ensures that the saturated magnetic moment of the ferromagnetic sphere remains oriented along the z-axis. As a result, the imaging contours of constant z-component of the magnetic field, B_{z}, remain fixed in space. Therefore, rotating the fixed sample/sphere system at a uniform sequence of angles φ provides all of the required imaging slices for previously developed two-dimensional computerized tomography reconstruction algorithms.

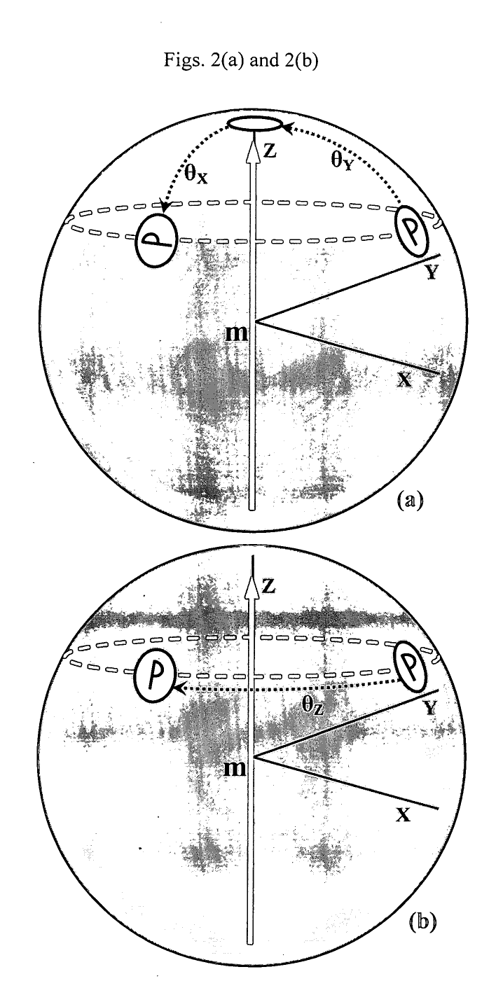

We note that, depending on the instrumental constraints or preferences, the actual rotation of the integrated ferromagnetic-sphere/sample system shown in FIG. 1 could also be experimentally executed by multiple sequential rotations around the x and y axes, as shown in FIGS. 2(a) and 2(b).

As rotations do not commute, such sequential rotations around x and y-axes would have to be carefully selected. For example, the rotation of the sample around θ_{y} and then around θx, shown in FIG. 2a, would result in the correct translation and rotation of the sample for proper tomographic slicing, while a single rotation around the z-axis, shown in FIG. 2b, would result in the correct translation but incorrect rotation of the sample for proper slicing by the contours of constant B_{z}. Additionally, we restrict our sample size to a fraction of the ferromagnetic sphere dimension in order to maintain the slicing of the sample by approximately parallel contours of constant B. We note that image reconstruction from non-parallel slices has been demonstrated in computerized tomography and is mathematically justified, so that it is in principle possible to envision imaging larger samples by the non-parallel magnetic field contours.

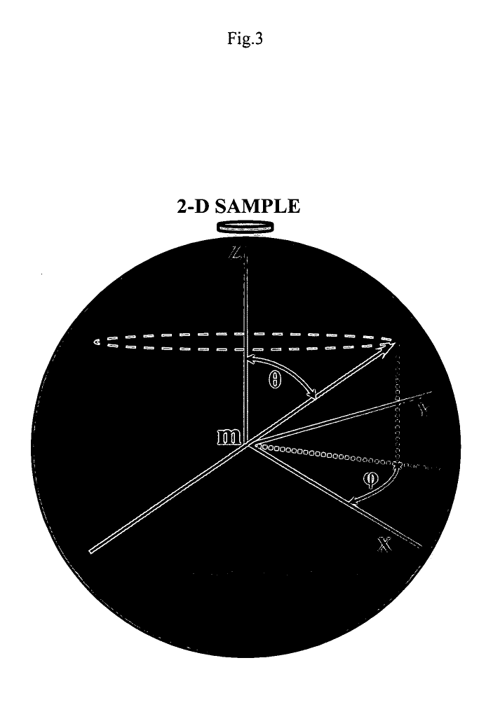

In order to extend our methodology to the three-dimensional imaging case, we find it advantageous to represent the integrated sphere/sample system rotations (described in FIGS. 1(a), 1(b), 2(a) and 2(b)) in a precessing ferromagnetic sphere moment reference frame, as shown in FIG. 3. In this perspective, although much harder to implement experimentally for a B₀=10 Tesla magnetic field, the same effect of image slicing as described in FIGS. 1(a), 1(b), 2(a) and 2(b) can be employed.

FIG. 3 is a diagram that illustrates a precessing ferromagnetic sphere moment reference frame for a two-dimensional sample. The sample is fixed and located on top of the sphere while the magnetic moment of the sphere is tilted away from the z-axis by θ=54.7° and precesses around the z-axis at a sequence of angles φ.

In this reference frame, the sample is fixed and located on top of the sphere, as shown in FIG. 3, while the ferromagnetic moment of the sphere is tilted away from the z-axis by θ=54.7° and precessed around the z-axis at a sequence of angles φ required for the tomographic image reconstruction process.

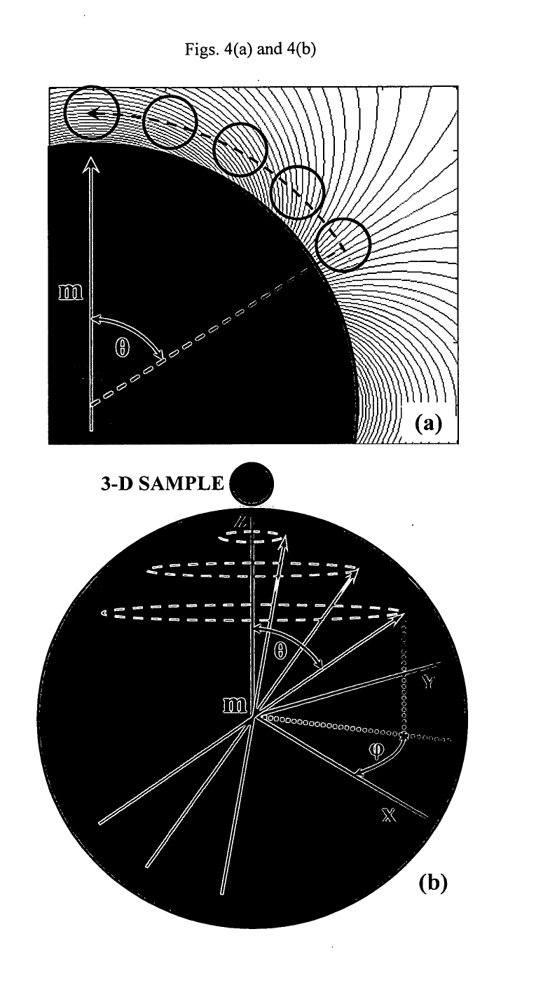

We now analyze the case of a three-dimensional sample mounted on a ferromagnetic sphere, as shown in FIGS. 4(a) and 4(b). FIG. 4(a) is a diagram that illustrates how a rotation of the integrated sample/sphere system from θ=54.7° to θ=0° results in the sequential slicing of the three-dimensional sample by the imaging planes that range from being approximately perpendicular to the sphere surface to being approximately parallel to the sphere surface. FIG. 4(b) is a diagram that illustrates the precessing magnetic moment reference frame for the three-dimensional tomography.

At the angular position of θ=54.7°, as in the two-dimensional imaging ease, the sample is intersected by the planes of constant z component of the magnetic field from the ferromagnetic sphere that are approximately perpendicular to the sphere surface. Consider now the rotation of the integrated sample/sphere system so that the angle φ=0° is held fixed while the angle θ is sequentially reduced in value from θ=54.7° to θ=0°. This results in the sequential slicing of the three-dimensional sample by the imaging planes that range from being approximately perpendicular to the sphere surface to being approximately parallel to the sphere surface, as FIG. 4(a) shows. Therefore, by rotating the sample/sphere system through several angular values that range from θ=54.7° to θ=0°, all the required imaging slices are obtained for two-dimensional image reconstruction along the x-z plane where angle φ=0°. This protocol again relies on the principle that, although both the sample and the sphere are mechanically rotated by the angle θ, the large polarizing magnetic field along the z axis ensures that the saturated magnetic moment of the ferromagnetic sphere remains oriented along the z-axis and the imaging contours remain fixed in space.

A three-dimensional imaging protocol follows directly from these principles as all of the slices needed for three-dimensional image reconstruction can be obtained by varying both angles φ and θ, as described in the precessing ferromagnetic sphere moment reference frame of FIG. 4(b). By sequentially varying the angles (θ, φ) of the ferromagnetic moment direction through all possible angular combinations from θ=54.7° to θ=0° and φ=0° to φ=360°, as shown in FIG. 4(b), the sample will be intersected by imaging slices at all possible angular orientations. This is sufficient for a complete three-dimensional image reconstruction, although several points of interest need to be addressed regarding the image-reconstruction process.

It is apparent from FIG. 4(a) that the planes of constant z-component of the dipolar magnetic field B_{z} from the ferromagnetic sphere are curved, non-parallel, and not equally spaced. This is not prohibitive for the image reconstruction procedure, as basic back-projection algorithms can be used for obtaining a three-dimensional image of the sample. More specifically, for an angular orientation (θ, φ), a weighted value is assigned to each contour of constant z-component of the magnetic field B from the magnetic resonance spectrum obtained at that angular orientation. The three-dimensional image reconstruction of the sample is then completed by repeating the weighted value assignment procedure for all angular orientations (θ, φ). Although this procedure is sufficient for basic three-dimensional image reconstruction, this simple back-projection algorithm is known to produce star-like image artifacts, and is therefore not optimal. It is believed that the application of the less artifact-prone but more complicated filtered back-projection algorithms or, alternatively, the matrix-based iterative-reconstruction algorithms may alleviate this problem.

A second point of interest is the image resolution. It is apparent from the inspection of the contours of constant z-component of the magnetic field in FIG. 4(a) that the image resolution depends on the distance from the ferromagnetic sphere surface. Only two magnetic field gradient forms are of interest since there is no variation of the azimuthally symmetric contours of the constant z-component of the magnetic field with the change of angle φ. The variation of the imaging contours along the radial direction is described by Equation 4, and the gradient of the imaging contours along the angular θ direction is:

$$\frac{1}{r} \frac{\partial {B}_{Z} ( \vec{r} )}{\partial θ} = - \frac{{M}_{0}}{{\vert \vec{r} \vert}^{4}} ( 6 cos θ sin θ ) = - \frac{3 {M}_{0}}{{\vert \vec{r} \vert}^{4}} sin 2 θ \qquad ( 5 )$$

Both gradients have an inverse radial dependence to the fourth power, which means that parts of the sample closer to the sphere will experience higher magnetic field gradients and therefore can in principle be imaged with a higher resolution. This can also be deduced from FIG. 4(a). Strong dependence of the gradient fields on r in Equations 4 and 5 also explains why the use of the nanoscale ferromagnetic spheres is advantageous in potentially obtaining atomic resolution images from projections. The idea of image reconstruction from projections in magnetic resonance dates back to the first MRI report published in 1973, and is currently performed in the technique of Stray Field Magnetic Resonance Imaging (STRAFI) where constant magnetic field gradients, on the order of 60 T/m, from superconducting magnets are used. Here, however, the nanometer scale ferromagnetic spheres provide ultra-high magnetic field gradients (˜5×10⁶ T/m for a 100 nm diameter Cobalt sphere), that can in principle be utilized for three-dimensional magnetic resonance imaging with resolution reaching Angstrom levels.

It is important to point out that in our imaging method it is not required to know a priori where the sample is located on the ferromagnetic sphere. If the ferromagnetic moment direction is sequentially varied through the angles (θ, φ) from θ=0° to θ=180° and φ=0° to φ=360°, the sample will be intersected by the imaging slices at all possible angular orientations, and a three-dimensional image reconstruction through back-projection algorithms will reveal an image and the location of the sample on the ferromagnetic sphere.

In addition to understanding the imaging methodology and resolution, it is important to discuss the consequences of our proposed imaging protocol to the choice of the experimental methods for magnetic resonance detection. Since our proposal involves a fixed ferromagnetic sphere with respect to the sample, force detection of magnetic resonance is excluded from the possible measurement choices. However, several other sensing mechanisms remain viable candidates for the implementation of this imaging method. Among these, cantilever detection could be employed. In addition to the force between the resonant spins and the ferromagnetic tip in MRFM, direct transfer of angular momentum and energy to the spin population in the magnetic resonance process can be detected using micro-mechanical cantilevers. The advantage in these mechanical detection techniques is that the sample can be fixed onto the sphere, as suggested in our imaging mode. Therefore, the need for scanning the sample with respect to the ferromagnetic probe is eliminated, along with the potential problems of long term positioning drift between the sample and the ferromagnetic gradient source. It is also important to note that, with the elimination of the relative motion of the sphere with respect to the sample, the thermo-mechanical vibrations of the cantilever do not translate into relative thermal motion and therefore fluctuations of the magnetic fields and field gradients from the sphere at the sample location. The intrinsic thermal motion of the magnetic moment remains, however, and has to be carefully considered in the ferromagnetic sphere material selection.

We also expect that optical and magnetic flux magnetic resonance detection schemes such as the micro-coil NMR, superconducting quantum interference devices (SQUID), Hall sensors, and superconducting resonators remain viable candidates to be implemented in this imaging method. Finally, a single or few nuclear spins detection schemes will require new understanding in the regime of quantum measurement, and have to involve careful consideration of the spin polarization and spin noise in the few-spins detection regime.

We have described a technique for magnetic resonance tomography using the dipolar magnetic fields from ferromagnetic spheres distinctly different from previous magnetic resonance force microscopy approaches that seek to achieve atomic imaging resolution. In previous experimental schemes, the images are obtained by raster scanning a ferromagnetic probe over the sample in three dimensions, and dc-convolving intensities from the obtained magnetic resonance spectra at each point. In contrast, in the dipolar field magnetic resonance tomography scheme described herein, the ferromagnetic sphere and the sample are fixed with respect to one another. We rely on the geometric symmetry of the sphere and on the principle that the ferromagnetic moment remains saturated and oriented along a large polarizing magnetic field despite the mechanical motion of the sphere. Angular positioning of the integrated sample/sphere system then provides all the required imaging slices for computerized tomographic image reconstruction. The elimination of the requirement of scanning the sample relative to a ferromagnetic tip in this new imaging protocol could represent a valuable experimental simplification and bring us closer to the goal of atomic resolution in three-dimensional nuclear magnetic resonance imaging. The present invention also contemplates obtaining images at resolutions on scales greater than atomic resolution (for example, micron resolution or resolution at even larger dimensions) using systems and methods in which there is no motion of the sample relative to the sphere.

The Apparatus and its Method of Operation

It is expected that an apparatus that can be used to perform two- and three-dimensional magnetic resonance imaging using ferromagnetic spheres will comprise the following components. Suitable ferromagnetic spheres (or ferromagnetic microspheres) are commercially available in dimensions of 100 nm diameter, or 100 μm diameter, as previously mentioned. The ferromagnetic microspheres can be coated with one or more chemical substances that allow the binding of one or more molecules or a physical object such as a biological cell of interest to the ferromagnetic microspheres. The chemical substances can be binders such as cements or molecular species having terminating groups that respectively adhere well to a metal and to a chemical site of a molecule or biological cell. A specimen of interest comprises a ferromagnetic microsphere and an object to be examined by nuclear magnetic resonance, such as a molecule or a cell, such that the ferromagnetic microsphere and the object are mutually attached to each other in a fixed mechanical relationship or orientation. The apparatus further is expected to comprise a magnetic field generator, such as a superconducting solenoid having a bore therein for accommodating a specimen holder that holds a specimen of interest. The specimen holder is expected to permit the positioning of the specimen at controlled angles θ and φ relative to the applied magnetic field. The apparatus additionally is expected to comprise at least one sensor for sensing a nuclear magnetic resonance signal generated by the specimen. The apparatus in some embodiments is expected to further comprise a general purpose programmable computer for controlling the operation of the apparatus, including some or all of controlling the applied magnetic field and the operation of the magnetic field generator, controlling the relative orientations of the specimen and the applied magnetic field, operating the one or more sensors, obtaining and recording nuclear magnetic resonance signals, and analyzing the nuclear magnetic resonance signals to obtain nuclear magnetic resonance imaging information about the specimen of interest.

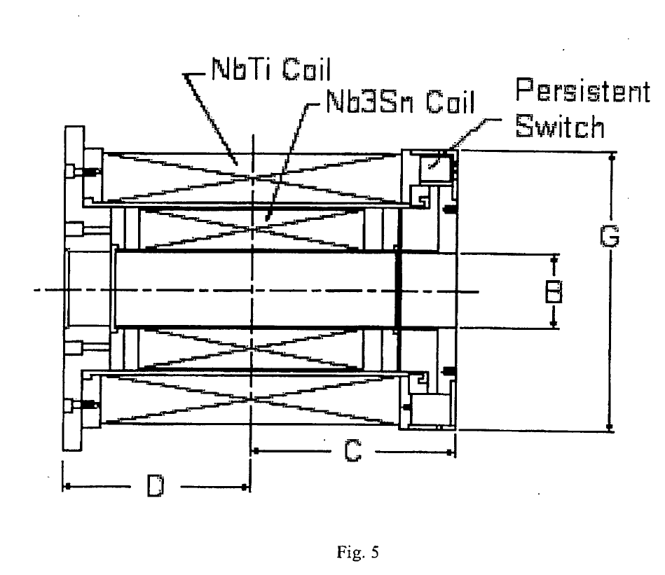

Magnetic field generating equipment is commercially available for generating controlled applied magnetic fields in the many-Tesla range. One example is available from Cryomagnetics, Inc., 1006 Alvin Weinberg Drive, Oak Ridge, Tenn. 37830. A superconducting solenoid magnet that is capable of approximately 19 T and having specifications including Homogeneity: +/−0.01% over 10 mm on axis; Inductance: 125 Henries nominal; Operating Current: 105 amperes (17 T, 4.2K); Clear Bore: 52 mm diameter; Overall Length: 385 mm (including low-field region coils); and Outside Diameter: 279 mm is described at the web page http://www.cryomagnetics.com/17-19t.htm. FIG. 5 is a diagram of a commercial superconducting magnet in cross section. The bore diameter is indicated by the dimension labeled “B” and can be of the order of 1.5 to 3 inches in diameter. Other types of magnets and the fields they can attain include resistive DC magnets (˜35 T), hybrid DC magnets (resistive+superconducting) (˜45 T), “long-pulse” magnets (100 ms) (˜60 T), “short-pulse” magnets (few ms) (˜100 T) and explosive short-pulse magnets (˜2,800 T).

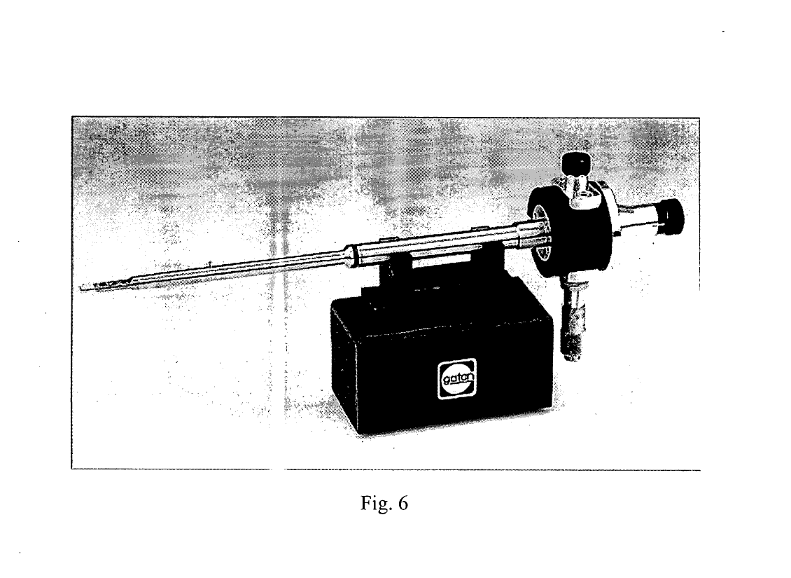

Specimen holders that permit at least two independent rotation (or rotation and tilt operations) and that are made from non-magnetic materials such as beryllium and titanium are available from Gatan Inc., 5933 Coronado Lane, Pleasanton, Calif. 94588 (http://www.gatan.com). The specimen holder shown in FIG. 6 is the Gatan Model 925 Double Tilt Rotation specimen holder (see http://www.gatan.com/holders/925 double.html). Goniometers for holding and orienting specimens are available commercially from vendors such as South Bay Technology Inc., 1120 Via Callejon, San Clemente, Calif. 92672 (see http://www.southbaytech.com/index.cfm) and HUBER Diffraktionstechnik GmbH & Co. KG, Sommerstrasse 4, D-83253 Rimsting, Germany (see http://www.xhuber.com/en/accessories/1000/content.htm).

One of the inventors has published (with others) a paper entitled “Scanning probe electromagnetic tweezers” (Appl. Phys. Lett., Vol. 79, pp. 1897-1899, 17 Sep. 2001) that describes apparatus and methods for manipulating micron-sized magnetic objects. It is possible using such methods to position a specimen of interest comprising a magnetic microsphere with an associated object on a sample holder so that measurements can be made on the specimen of interest.

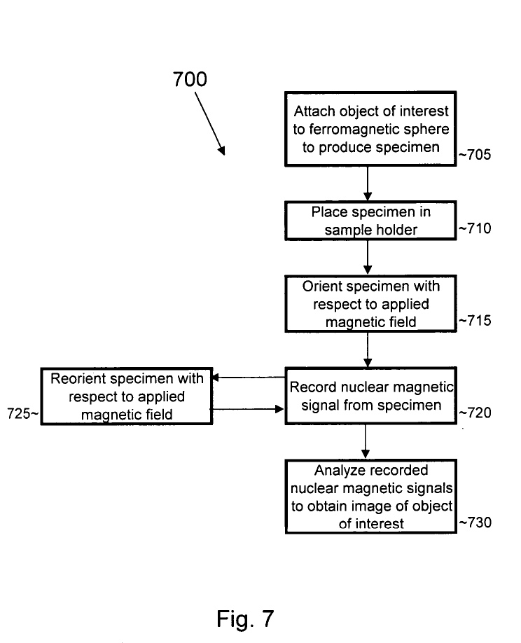

FIG. 7 is a flow diagram 700 illustrating one embodiment of the method of operation of the apparatus. As indicated at step 705, one attaches an object of interest to ferromagnetic sphere to produce a specimen. As indicated at step 710, one places the specimen in a sample holder. As indicated at step 715, one orients the specimen with respect to the applied magnetic field by manipulating the sample holder to rotate the specimen along at least one of two mutually perpendicular rotation axes. As indicated at step 720, one records a nuclear magnetic signal from the specimen at the orientation that was set in step 715. As indicated at step 725, one reorients the specimen with respect to the applied magnetic field to allow additional data to be measured. As indicated at step 720, one records a nuclear magnetic signal from the specimen at the orientation that was set in step 725. One can repeat steps 725 and 720 iteratively to obtain as many nuclear magnetic resonance signals as may be useful. As indicated at step 730, one analyzes the recorded nuclear magnetic signals to obtain an image of the object of interest.

In one embodiment, in operation, the magnetic resonance data is obtained from a specimen of interest by attaching the specimen attached in a fixed orientation or relationship to a magnetic microsphere, placing the magnetic microsphere in an applied magnetic field B₀ at an initial orientation (θ₀, φ₀) relative to the applied magnetic field, and measuring a signal from the specimen. The measurement of the signal is allowed to continue until a suitable value of signal relative to noise (e.g., an acceptable signal-to-noise ratio) is obtained. The magnetic microsphere with the specimen attached thereto is then rotated to a new orientation (θ₁, φ₁) relative to the applied magnetic field B₀. The rotation can be applied to the magnetic microsphere with the magnetic field B₀ held in a fixed orientation. Alternatively, it is possible in principle that the magnetic microsphere can be held in a fixed orientation and the applied magnetic field B₀ can be rotated relative to the magnetic microsphere, although rotating the applied magnetic field B₀ is in general a more difficult and cumbersome operation than rotating the magnetic microsphere. With the magnetic microsphere in the new orientation (θ₁, φ₁) relative to the applied magnetic field, another signal is obtained, again continuing the measurement until an acceptable signal-to-noise ratio is obtained. As appropriate and useful, the magnetic microsphere is reoriented relative to the applied magnetic field at one or more additional orientations (θᵢ, φⱼ), where θᵢ, φⱼ represent successive values of θ and φ that are selected by a user or by the general programmable computer upon which a software module is operating that controls the operation of the apparatus, and additional signals are observed and as necessary, recorded. Additional software module(s) operate on the general purpose programmable computer to control the recording of the signals (e.g., the data), and to analyze the signals or data.

After a sufficient number of the magnetic resonance signals are obtained from a specimen by application of the systems and methods described hereinabove, the magnetic resonance signals are analyzed using a general purpose programmable computer upon which one or more suitable analysis software modules are operated. The analysis software accepts as input the magnetic resonance data and provides as output an image of the specimen represented as one or more tomographic sections in one or more orientations of interest. As will be understood, higher resolution output can be obtained by recording more signals (e.g., more data) at a larger number of orientations, and by recording data having a higher signal-to-noise ratio as compared to signals having a lower signal-to-noise ratio. The exact number of required signals and the appropriate signal-to-noise ratio will be determined by the resolution that one wishes to obtain, e.g., the higher the desired resolution, the greater the number of signals and/or the greater the signal-to-noise ration that will be required, all other things being equal.

Programmable General Purpose Computers

Programmable general purpose computers useful for controlling instrumentation, recording signals and analyzing signals or data according to the present description can be any of a personal computer (PC), a microprocessor based computer, a portable computer, or other type of processing device. The programmable general purpose computer typically comprises a central processing unit, a storage or memory unit that can record and read information and programs using machine-readable storage media, a communication terminal such as a wired communication device or a Wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of Unix, or of Linux.

Machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein.

Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. An apparatus for obtaining a nuclear magnetic resonance image, comprising:
a magnetic field generator configured to generate a large polarizing DC magnetic field B₀ and a small radio frequency field B₁ oriented perpendicular to said large polarizing DC magnetic field B₀;
a specimen holder configured to support a specimen comprising an object of interest attached in fixed relation to a magnetic sphere, said specimen holder configured to permit said specimen to be oriented at a plurality of orientations relative to said large polarizing DC magnetic field B₀;
a sensor for sensing a nuclear magnetic resonance signal; and
an analyzer for analyzing said sensed nuclear magnetic signals;
whereby said apparatus is configured to generate at least one nuclear magnetic resonance image of said object of interest.

2. The apparatus for obtaining a nuclear magnetic resonance image of claim 1, further comprising:
a general purpose programmable computer programmed with software, said general purpose programmable computer configured to control at least a selected one of the applied magnetic field, the operation of the magnetic field generator, and the relative orientations of the specimen and the applied magnetic field.

3. The apparatus for obtaining a nuclear magnetic resonance image of claim 1, wherein said magnetic field generator comprises a superconducting solenoid.

4. The apparatus for obtaining a nuclear magnetic resonance image of claim 1, wherein said large polarizing DC magnetic field B₀ comprises a magnetic field of at least 10 Tesla.

5. The apparatus for obtaining a nuclear magnetic resonance image of claim 1, wherein said specimen holder is configured to allow rotation of the specimen along at least one of two mutually perpendicular rotation axes.

6. The apparatus for obtaining a nuclear magnetic resonance image of claim 1, wherein said magnetic sphere has a diameter of 100 μm or less.

7. The apparatus for obtaining a nuclear magnetic resonance image of claim 6, wherein said magnetic sphere has a diameter of 100 nm or less.

8. The apparatus for obtaining a nuclear magnetic resonance image of claim 1, wherein said magnetic sphere comprises a selected one of cobalt, iron, and nickel.

9. The apparatus for obtaining a nuclear magnetic resonance image of claim 1, wherein said magnetic sphere is a selected one of a ferromagnetic sphere and a ferromagnetic sphere.

10. A method for obtaining a nuclear magnetic resonance image, comprising the steps of:
attaching an object of interest in a fixed relation to a magnetic sphere to produce a specimen;
placing the specimen in a sample holder;
orienting the specimen with respect to an applied magnetic field by manipulating the sample holder to rotate the specimen along at least one of two mutually perpendicular rotation axes;
recording a nuclear magnetic signal from the specimen at the orientation;
reorienting the specimen with respect to the applied magnetic field;
recording a nuclear magnetic signal from the specimen in the reoriented position; and
analyzing the recorded nuclear magnetic signals to obtain an image of the object of interest.

11. The method for obtaining a nuclear magnetic resonance image of claim 10, wherein the steps of reorienting the specimen with respect to the applied magnetic field and recording a nuclear magnetic signal from the specimen in the reoriented position are repeated iteratively.

12. The method for obtaining a nuclear magnetic resonance image of claim 10, wherein said magnetic sphere comprises a selected one of cobalt, iron, and nickel.

13. The method for obtaining a nuclear magnetic resonance image of claim 10, wherein said magnetic sphere is a selected one of a ferromagnetic sphere and a ferromagnetic sphere.

14. The method for obtaining a nuclear magnetic resonance image of claim 10, wherein said magnetic sphere has a diameter of 100 μm or less.

15. The method for obtaining a nuclear magnetic resonance image of claim 10, wherein said magnetic sphere has a diameter of 100 nm or less.

16. The method for obtaining a nuclear magnetic resonance image of claim 10, wherein at least one of the step of orienting the specimen with respect to an applied magnetic field and the step of reorienting the specimen with respect to the applied magnetic field is performed using a general purpose programmable computer.

17. The method for obtaining a nuclear magnetic resonance image of claim 10, wherein the step of recording a nuclear magnetic signal from the specimen is performed using a general purpose programmable computer.

18. The method for obtaining a nuclear magnetic resonance image of claim 10, wherein the step of analyzing the recorded nuclear magnetic signals is performed using a general purpose programmable computer.
